(19) United States
(12) Patent Application Publication
(10) Pub. No.: US 2012/0218282 A1
(43) Pub. Date: Aug. 30, 2012

(54) Display Brightness Adjustment

(75) Inventors: Kevin Joseph Choboter, Waterloo (CA); Antanas Matthew Broga, Cambridge (CA)

(73) Assignee: Research In Motion Limited, Waterloo (CA)

(21) Appl. No.: 13/035,120

(22) Filed: Feb. 25, 2011

(51) Int. Cl. G09G 5/02

(52) U.S. Cl. 345/589

(57) ABSTRACT

Concepts are described pertaining to controlling a brightness level of a display of a portable electronic device as a function of the ambient light, and controlling the display brightness level to accommodate human light or dark adaptation.

### TECHNICAL FIELD

The present disclosure relates generally to portable electronic devices, electronic communications, and more particularly to systems and methods for controlling the brightness of a portable electronic device having a display.

### BACKGROUND

Many portable electronic devices include a display that presents to a user images in various forms, such as video, still photographs, text, icons and graphics. Some displays, such as some liquid crystal displays (LCDs), include a backlight that illuminates the image and generates most of the light emitted from the display. Other displays are self-emissive or self-illuminating, such that the pixels of the emit light, often without the need a backlight. Many displays have a controllable brightness level. Brightness may be controlled by controlling the emission of light from the backlight or from the pixels, or both.

### BRIEF DESCRIPTION OF THE DRAWINGS

The accompanying figures, where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 depicts a portable electronic device according to one example;

FIG. 2 depicts a block diagram of the portable electronic device of FIG. 1, and associated components in which the apparatus and methods disclosed herein may be implemented, in the context of an illustrative communication system, according to one example;

FIG. 3 graphically depicts illustrative brightness control of a display in relation to an illustrative model of dark adaptation, according to one example;

FIG. 4 graphically depicts a different illustrative brightness control of a display in relation to an illustrative model of dark adaptation, according to one example;

FIG. 5 is a flow chart illustrating a method, in which display brightness is changed to accommodate adaptation, according to one example;

FIG. 6 is a flow chart illustrating example techniques by which a substantial change in ambient lighting may be determined, according to one example; and

FIG. 7 is a flow chart illustrating another method, iii which display brightness is changed to accommodate adaptation, according to one example.

### DETAILED DESCRIPTION

The concepts described below generally pertain to brightness adjustment, that is, controlling the brightness of a display of a portable electronic device. Many portable electronic devices are transported in ordinary use to different light environments. Light environments may typically range from a brightly sunlit environment to a pitch-black room. Some portable electronic devices are handheld, that is, sized to be held or carried in a human hand. Examples of portable electronic devices that may have displays include cell phones, personal digital assistants (PDAs), smart phones, tablet-style computers, portable DVD players, global positioning system (GPS) units, laptop computers and remote controls.

Portable electronic devices often include a light sensor that senses the ambient light levels. The portable electronic devices may adjust the brightness of the display as a function of the ambient light, to make the displayed images easier for a human being to see. In a typical example, when a portable electronic device is brought from sunlight into a dark room (e.g., less than 1 lux, lux generally being a measurement unit of the ambient light intensity as perceived by the human eye), the light sensor detects the low ambient light level and the device may automatically set the brightness to a level appropriate for a dark environment. The brightness of the display in a “dark” environment may be dimmer than for a sunlit environment.

It has been discovered by experimentation and experience that a display brightness setting or adjustment that is initially satisfactory may become less so. For example, when the brightness of the display is dimmed to correspond to the low level of light, the amount of brightness may be initially acceptable. As the user's eyes adjust to the darkness, however, this level of brightness of the display can be less satisfactory, perhaps even straining, overpowering and uncomfortable to view.

In some cases, the user's eyes may be adapted to a darkness level, and when a darkened display is illuminated, the brightness may be perceived as uncomfortably high. An example of a situation such as this is when a user is in bed in a pitch black room, and then the display becomes illuminated (e.g., to display an incoming telephone call).

The process by which human eyes become accustomed to a lighting environment is called adaptation. The process whereby eyes adapt from a darker environment to a lighter environment is light adaptation, and the process whereby eyes adapt from a lighter environment to a darker environment is dark adaptation. Adaptation results from a biochemical process. The exact biochemical processes and mechanisms behind adaptation are not essential to the concepts discussed herein, but the following is provided for general information. In general, human eye sensitivity to light is a function of (i.e., depends upon) the amount of photopigments present in the rod and cone cells in the retina. There are four different kinds of photopigments. One kind of photopigment is present in the rod cells, which are sensitive to black-and-white, and three other kinds are in the cone cells, which are sensitive to colour. The different photopigments in the cone cells make them sensitive to different colours.

Photopigments undergo chemical alterations when exposed to light, breaking down (dissociating into different biochemical components) in the presence of light. As photopigments in the rod or cone cells breaks down, the cells become less sensitive to light. If the light is removed, a broken down photopigment is reset automatically with the aid of enzymes. In the dark, black-and-white vision (using the rod cells) becomes predominant, and dark adaptation principally involves the rod cells becoming more sensitive as the photopigments reset in the absence of light. Light and dark adaptation are essentially involuntary physiological processes.

Further, adaptation takes time. As many people are aware from their own experience, it takes some minutes for the human eye to adapt to a markedly new bright or dark environment. According to some estimates, full adaptation from bright sunlight to total darkness can take from twenty to thirty minutes (although functional adaptation may take about half as long or less). Adaptation need not be constant; some sources recognize that there may be fast and slow phases of adaptation, and that cone cells and rod cells take different times to adapt. Moreover, adaptation in many people can affect the sensitivity of the eyes dramatically. According to one estimate, human eyes in their most sensitive state are a million times more sensitive than when they are in their least sensitive state.

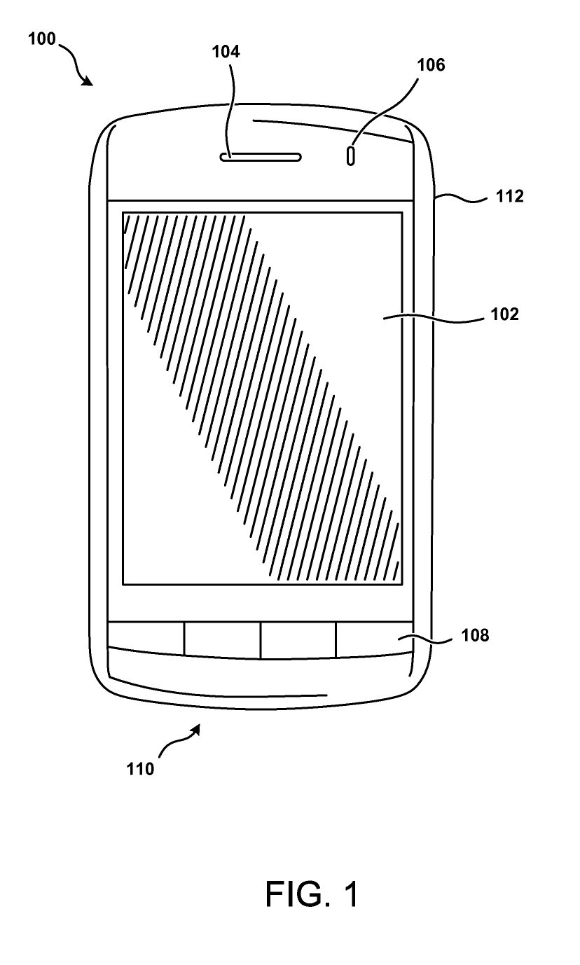

The concepts described herein pertain to controlling a display brightness level as a function of the ambient light, and controlling a display brightness level to accommodate human light or dark adaptation. FIG. 1 depicts an example of a portable electronic device 100 that may illustrate the concepts. As will be discussed, the portable electronic device 100 and various components thereof may be configured or adapted to carry out the operations of the concept. (In general, if a component is “configured to” or “adapted to” perform a function, that component is capable of carrying out that function.) The portable electronic device 100 is based on a computing platform having functionality of a personal digital assistant with cell phone and e-mail features. Portable electronic device 100 includes a display 102. The display 102 may be any kind of a display, including a backlit display or a self-emissive display or any combination thereof. As depicted in FIG. 1, the display 102 may be a touch screen display, which presents images and also serves as an input device through which a user may give commands to or otherwise interact with portable electronic device 100. A characteristic of the display 102 is its brightness. The brightness of a display 102 may be a function of the brightness of (for example) individual pixels, the brightness regions of the display 102, the brightness of a backlight (if any), or any combination thereof. The brightness of the display 102 is controllable, as described in more detail below.

Additional components of portable electronic device 100 may include a speaker 104, an indicator (such as an LED indicator) 106, one or more buttons or keys 108 that may serve as input devices, and a microphone 110 (which has a structure not visible in FIG. 1). Additional features may include a touchpad, trackball, one or more dedicated function keys, and the like. A housing 110 generally provides a supporting frame for display 102 and for various external and internal components of the portable electronic device 100. An alternative embodiment of the portable electronic device 100, not shown in FIG. 1, may incorporate a set of external keys, such as a keyboard. The keyboard, or keys 108, may be illuminated and the brightness of the illumination may be controllable. Further, controlling of the brightness of the keys may be similar in many respects to controlling the brightness of the display 102. For purposes of simplicity, however, the discussion below will focus upon the controllability of the brightness of the display 102.

The portable electronic 100 may conduct wireless communication (which may be two-way or one-way) via one or more wireless systems, including wireless telephone systems, infrared systems, Bluetooth (trade-mark) and the many forms of 802.11 wireless broadband systems, over-the-air television or radio broadcasting systems, satellite transmission systems, and the like.

The indicator 106 may illuminate (or may flash on and off) to indicate an event to a user, such as the receipt of a new email message. In some embodiments, indicator 106 may serve a dual function, acting as a sensor of ambient light. An example of such an indicator is a light emitting diode (LED), which can emit light as an output in response to a voltage input, and which can also receive ambient light as an input and generate a voltage as a function of the intensity of the ambient light. In other embodiments, a dedicated light sensor may generate a signal as a function of the ambient light. An indicator and a light sensor may be, but need not be, in close proximity to one another.

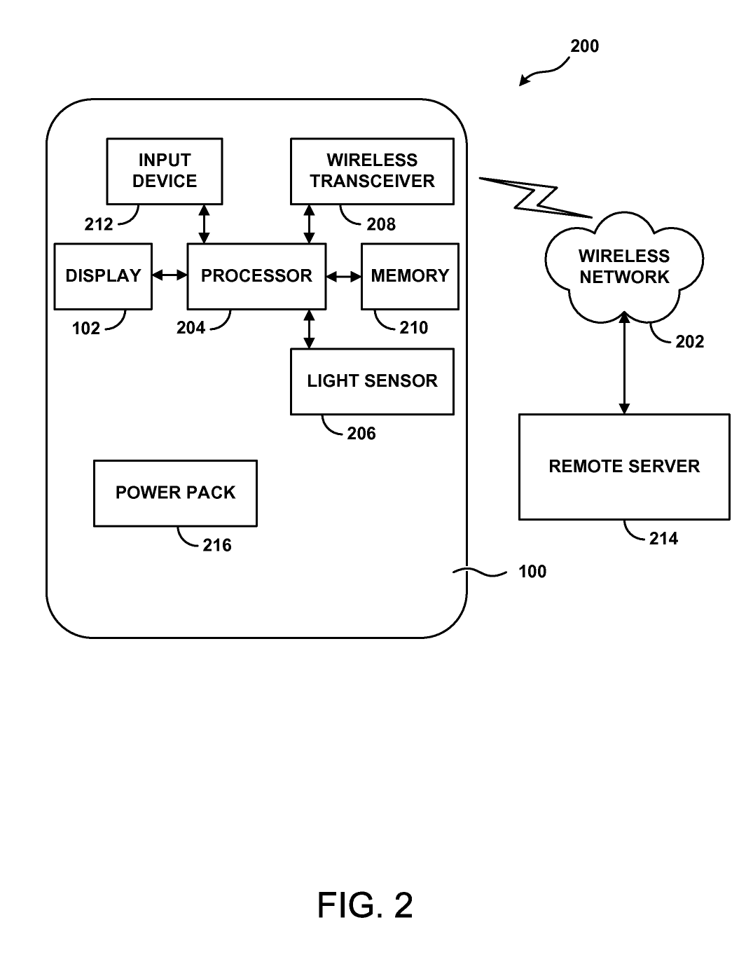

FIG. 2 is a block diagram depicting the portable electronic device 100 in one example of a communications system 200. The communications system 200 may includes a wireless network 202, such as a cellular telephone network. The portable electronic device 100 comprises a processor 204 coupled to the display 102. The processor 204 may include any electronic component that can control the brightness of the display 102. The processor 204 may further include a component that can measure time. In the example of FIG. 2, the processor 204 may be a multi-purpose microprocessor that controls many other functions or operations of the portable electronic device 100. The processor 204 may be embodied as a unitary component or as a collection of components.

The brightness of the display 102 may be controlled by any of several techniques, depending on the kind of display being controlled. For some displays, the brightness may be controlled by controlling the power supplied to the display or the power supplied to components of the display. In some self-emissive displays, the light emitted by a pixel or group of pixels may be controlled. For a display with a backlight, more or fewer illuminating elements may be turned on, or the time intervals for illuminating the illuminating elements may be lengthened or shortened (e.g., via pulse-width modulation). The concepts described herein are not restricted to any particular technique or techniques for controlling the brightness of a particular display.

The portable electronic device 100 further comprises a light sensor 206. As indicated above, the light sensor 206 may be embodied as an LED. The light sensor 206 receives ambient light as an input and generates an ambient light signal—that is, an electrical signal that is generated to have one or more properties (such as a voltage, a current, a duty cycle of a periodic signal, a frequency, etc.) as a function of the ambient light—and supplies that ambient light signal to the processor 204. The processor 204 controls the brightness of the display 102 as a function of (based at least in part on) the ambient light signal. In a typical implementation, the light sensor 206 is not continuously active. Instead, the light sensor 206 samples the ambient light periodically. The frequency of sampling need not be any particular frequency, but sampling in the range of 0.5 Hz to 3 Hz may be typical in active usage. When the portable electronic device 100 is “asleep” (discussed below), the frequency of sampling of ambient light levels might be substantially lower. The sampling frequency is under the control of the processor 204.

The processor 204 may control the brightness of the display 102 as a function of other factors as well. In some cases, processor 204 may control the brightness of the display 102 by turning the display off. If the display 102 is illuminated for a period of time, for example, and the portable electronic device 100 experiences no user input during that period of time, the processor 204 may turn off the display 102 to conserve power. In some embodiments, sampling of the ambient light levels via the light sensor 206 may be suspended when the display 102 is turned off, or the sampling may take place at a reduced frequency. The processor 204 may turn on the display 102 again in response to an event such as a user touching a key 108. Although not depicted in FIG. 2, the portable electronic device 100 may include one or more devices by which the processor 204 may determine that the light sensor 206 may be blocked. For example, some portable electronic devices include sensors that can detect whether the device is housed in a holster or a closed container, and in cases such as these, the functionality of the light sensor 206 may be suspended because ambient light signals generated by the light sensor 206 might not necessarily be good indicators of ambient light.

FIG. 2 also depicts a wireless transceiver 208, a memory 210, and an input device 212. The wireless transceiver 208 supports wireless communication between the portable electronic device 100 and a remote element, such as a server 214. Memory 210 may comprise volatile memory, such as RAM, or non-volatile memory, such as flash RAM or a hard drive. The input device 212 may comprise any element by which a user may give commands to or otherwise interact with the portable electronic device 100, such as keys 108, or a touchpad or a trackball. In some embodiments, a touch screen may be an embodiment of the input device 212.

The processor 204 may execute instructions that may be stored in memory 210, including instructions pertaining to carrying out the concepts described herein. The processor 204 or memory 210 may obtain the instructions from one or more computer readable media. In general, machine-readable data, instructions (or program code), messages, message packets, and other computer-readable information may be stored on a computer readable medium. A computer readable medium may include computer readable storage medium embodying non-volatile memory, such as read-only memory (ROM), flash memory, disk drive memory, CD-ROM, and other permanent storage. Additionally, a computer readable medium may include volatile storage such as RAM, buffers, cache memory, and network circuits. Furthermore, the computer readable medium may comprise computer readable information in a transitory state medium such as a network link and/or a network interface, including a wired network or a wireless network, that allow a machine, such as the processor 204, to read and make use of such computer readable information. In some embodiments, the instructions may be embodied as a tangible and non-transitory computer program product comprising a computer readable medium embodying program code executable by a processor (such as processor 204) that cause the processor to execute any of the methods or variants described herein.

A power pack 216 supplies power to the various electronic components in the portable electronic device 100. The power pack 216 may be any form of power supply, such as a conventional rechargeable battery, a fuel cell system, a solar cell, or the like, or any combination thereof. Although the portable electronic device 100 in some implementations may be electrically connectable to a fixed power supply such as a wall outlet, it is generally desirable that the power supply 216 support the portability of the portable electronic device 100.

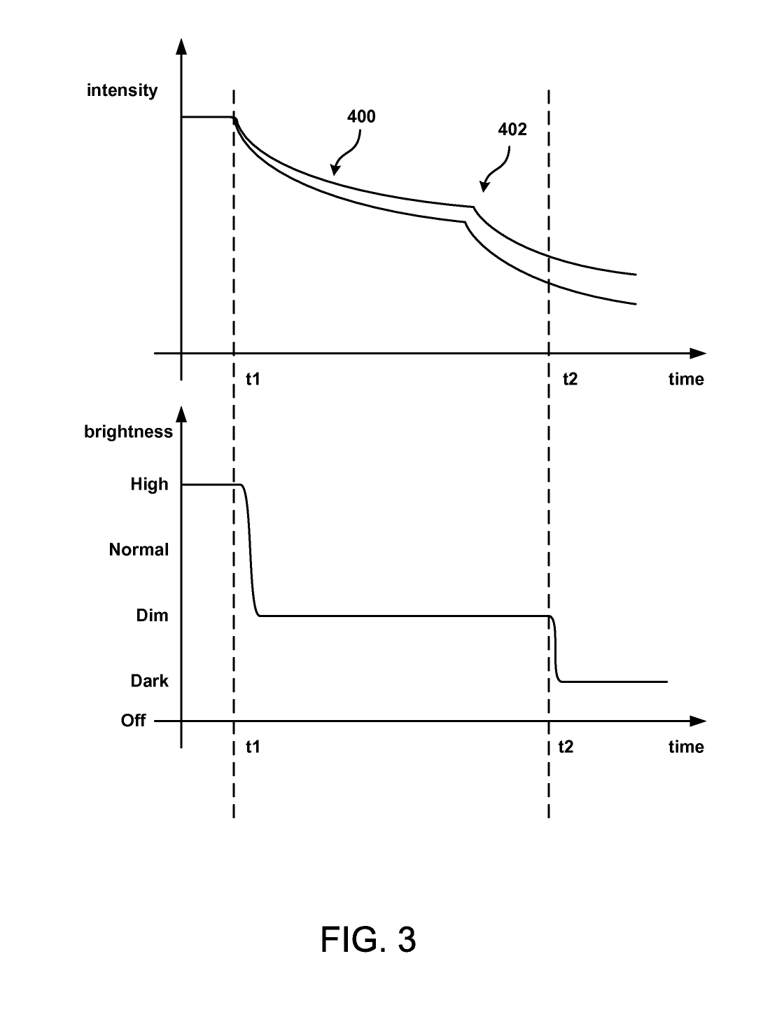

FIG. 3 includes two graphs illustrating an embodiment of the concept, in the context of dark adaptation. The top graph depicts an illustrative range of dark adaptation curves 400. The dark adaptation curves 400 indicate a typical range of dark adaptation in human beings. The vertical axis (which may be in log scale) represents the intensity that produces a visual sensation in a human eye. In general, the less sensitive the eye is, the greater the intensity of light to produce a sensation. The horizontal axis represents time. Prior to time t1, the eye is adapted to a bright environment. The curves in the top graph may be mathematically represented as a typical dark adaptation curve, or a typical range of dark adaptation curves, that model dark adaptation of human eyes.

At time t1, the eye moves abruptly from a bright environment to a dark environment (e.g., less than 1 lux). Very quickly dark adaptation begins. Cone cells adapt more quickly than rod cells. After a while (typically five to ten minutes), a marked bend 402 appears in the adaptation curves. This bend is called the rod-cone break 402, at which the rod cells become more sensitive than the cone cells. In general, the sensitivity of the eye increases over time as the photopigments in the eye reset.

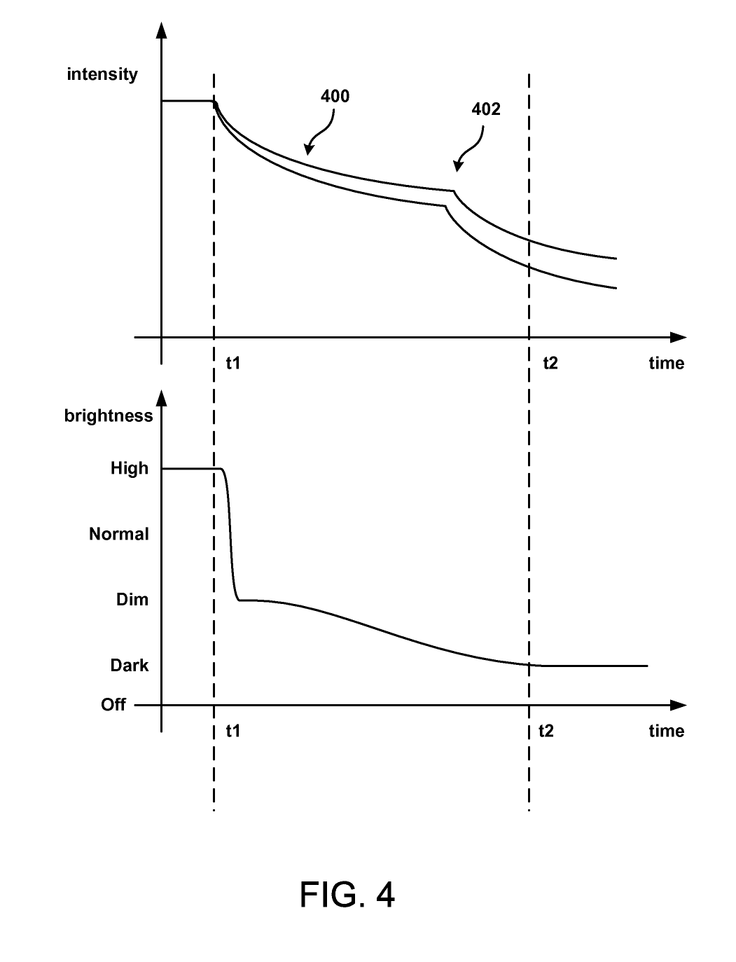

The bottom graph illustrates one implementation of the brightness control of the display 102. In this illustration, the processor 204 can set the brightness of the display 102 to any of five substantially discrete brightness levels: “high,” “normal,” “dim,” “dark” and “off” At time t1, the intensity of the ambient light drops, and the light sensor 206 generates an ambient light signal as a function of the lower intensity of ambient light. In response, the processor 204 controls the brightness of display 102 to set the brightness to “dim.” (Although depicted in FIG. 3 as a rapid transition, the processor 204 may control the brightness of display 102 through a less abrupt and more aesthetically pleasing transition from one brightness level to another.) At a later time t2, the intensity of the ambient light may remain substantially the same, but the processor 204 controls the brightness of display 102 to set the brightness to “dark,” which is less bright than “dim.” The change of brightness is not a function of a change in ambient light (because ambient light is substantially unchanged), but rather is a function of the time. In general, the time is a function of how long it takes for a human eye to adjust to the darker environment. By time t2, the eye has regained enough sensitivity that the brightness need not be set to “dim” to be seen clearly. The eye may be sufficiently sensitive that the “dim” setting may seem unpleasantly bright, and the “dark” setting is more pleasant to view. The time between t1 and t2, which may be referred to as an adaptation interval, may be of any duration. Typically, however, the adaptation interval may be about ten minutes (e.g., about ten minutes from the time that the substantial change in ambient light is detected, or about ten minutes from the time that the processor 204 controls the brightness of display 102 to set the brightness to “dim,” which typically occurs shortly thereafter), although typical adaptation intervals may be between five minutes and half an hour. Although depicted in FIGS. 3 and 4 as occurring after the rod-cone break 402, t2 may be selected to occur before a typical rod-cone break point would occur. Importantly, a mathematical model for human eye adaptation need not be exact or all-encompassing, nor does it need to be calibrated for any particular user. The portable electronic device 100 may store a mathematical adaptation model in memory 210 and may control the brightness of the display 102 as a function of an adaptation model, but this degree of control (while within the scope of the concept) is not necessary to the concept. By controlling a display brightness level after an adaptation interval has elapsed without a substantial change in ambient light—that is, even though there has not been a substantial change in the ambient light level—the portable electronic device 100 may control the brightness of the display 102 to accommodate adaptation.

FIG. 4 includes two graphs illustrating an alternate embodiment of the concept. As in FIG. 3, the top graph depicts illustrative dark adaptation curves 400, and the bottom graph illustrates one implementation of the brightness control of the display 102. In this illustration, the processor 204 controls the brightness of display 102 to set the brightness to “dim” at or shortly after t1. As in FIG. 3, the eye moved abruptly from a bright environment to a dark environment, and in response, the processor 204 controls the brightness of display 102 to set the brightness to “dim” fairly quickly. As in FIG. 3, the intensity of the ambient light may remain without substantial change over time.

In FIG. 4, unlike FIG. 3, the processor 204 controls the brightness of display 102 to set the brightness to “dark,” but does so gradually. As the eye becomes gradually more sensitive, the brightness of the display 102 gradually dims. That is, the initial brightness of the display is set to “dim” when the portable electronic device 100 is first brought into a dark room, but then the brightness is gradually reduced as the user's eyes adjust to the darkness. In one implementation, the processor 204 may execute a slow fade routine using fuzzy logic states to reduce the level of brightness from the “dim” state through a sequence of intermediate states to the “dark” state.

Effects similar to those depicted in FIGS. 3 and 4 can be applied to light adaptation. For example, if the intensity of the ambient were suddenly to rise from dark to very light, the light sensor 206 would generate an ambient light signal as a function of the higher intensity of ambient light. In response, the processor 204 may control the brightness of display 102 to set the brightness to “normal.” At a later time, even though the intensity of the ambient light may remain substantially the same, the processor 204 may control the brightness of display 102 to set the brightness to “bright.”

In the scenarios depicted in FIGS. 3 and 4, if the ambient light were abruptly to change to a brighter ambient light before time t2, the processor 204 may interrupt the dimming of the display 102 to “dark,” and may instead control the brightness to select a level as a function of the new level of ambient light.

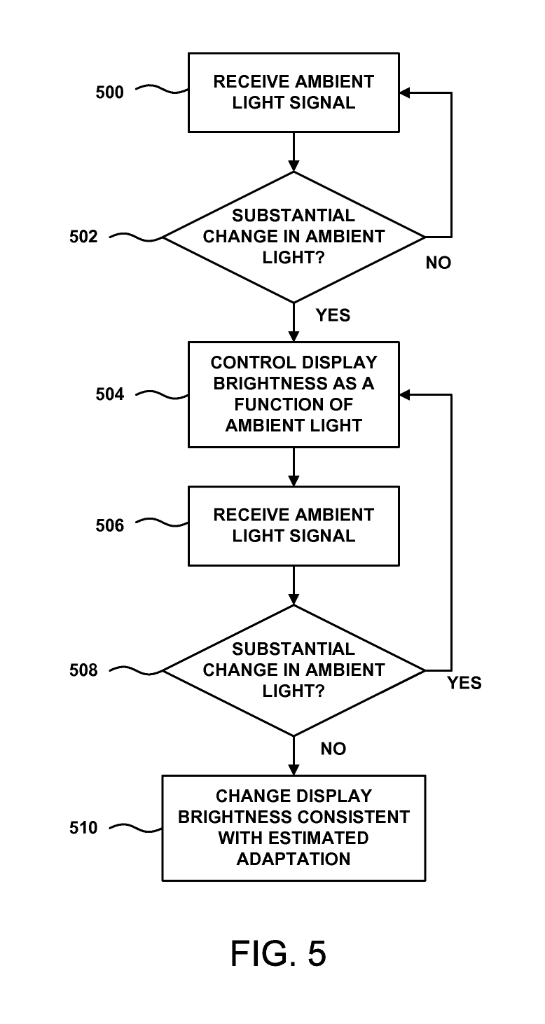

FIG. 5 is a flowchart illustrating a method that may be carried out automatically by a portable electronic device 100, typically by the processor 204. In this method, it may be assumed for simplicity that the display 102 is on and displaying an image. (A variant of this method may also be applied where the user interaction with the portable electronic device 100 is intermittent, and the portable electronic device 100 temporarily shuts off the display 102 during the periods of activity.) It may further be assumed that the processor 204 is controlling the brightness level of the display at a first brightness level as a function of the ambient light. The processor 204 receives an ambient light signal from the light sensor 206 (500). This ambient light signal is a function of the level of current ambient light, as sensed by the light sensor 206. The ambient light signal may itself be a value (such as an estimated lux value) or another quantity (such as a voltage, a current, a duty cycle of a periodic signal, a frequency, etc.) that is a function of the measured current level of ambient light. The processor 204 may determine the level of ambient light as a function of the ambient light signal. The processor 204 may, for example, recognize the ambient light signal itself as the quantity representing the current ambient light level, or the processor 204 may convert or derive another quantity for the ambient light level as a function of the ambient light signal (e.g., the processor 204 may convert a voltage signal in units of volts to an estimated ambient light level in units of lux). The processor 204 may store in memory 210 the ambient light level by storing the quantity.

The processor 204 may have stored in a buffer in memory 210 quantities representing one or more previous ambient light levels, based upon previous ambient light signals. For example, the processor 204 may store in the buffer ambient light levels representing the five most recent ambient light level samples. As new ambient light signals are received, the older ambient light data in the buffer may be discarded or overwritten. As will be discussed below, the processor 204 may process the ambient light levels in the buffer by (for example) taking the arithmetic mean or computing the median. By comparing the level of current ambient light (by itself or along with other levels of ambient light) to one or more previous levels of ambient light, the processor 204 can determine whether there has been a substantial change in ambient light (502).

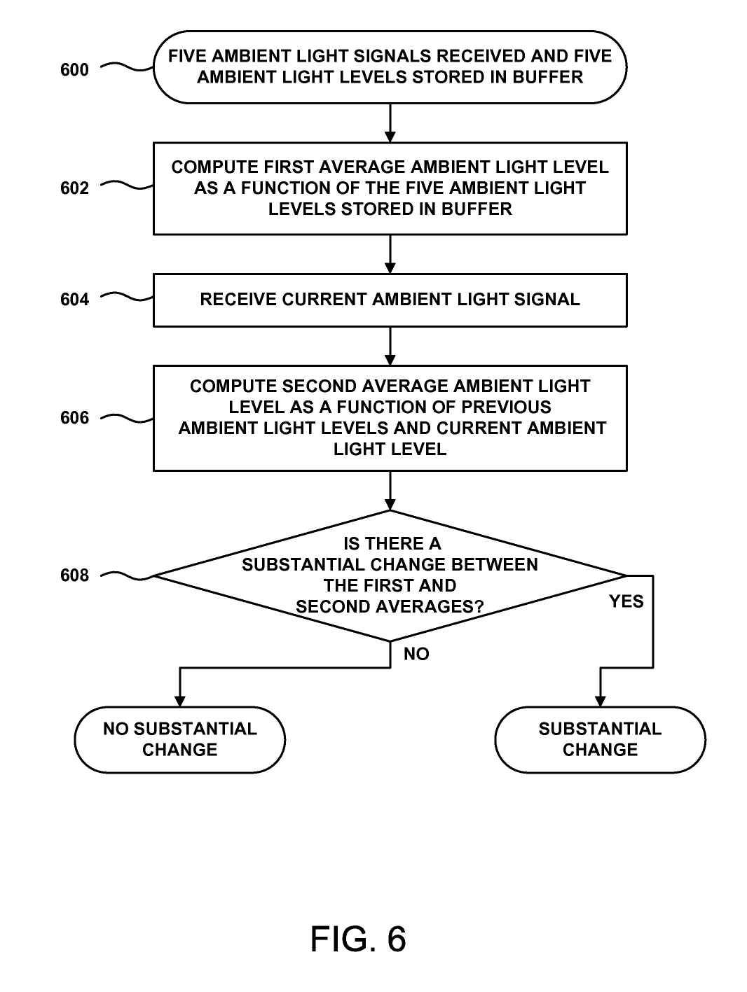

Whether a change in ambient light is substantial or not may depend upon several considerations. It is not a substantial change if there is no change at all in the level of ambient light; there may also be measurable changes in the ambient light level that are nevertheless deemed not substantial. One technique by which a change in ambient light may be deemed substantial is to determine whether the current ambient light level is in the same range as one or more previous ambient light levels. If the current ambient light level is not in the same range as one or more previous ambient light levels, then (according to this technique) there has been a substantial change in ambient light. For example, the processor 204 may deem ambient light levels above 3,000 lux to be a “bright” light environment. In such a scheme, a change of ambient light level from 5,000 lux to 25,000 lux would be without a substantial change in ambient light level, because even though the luminance changes many-fold, the ambient light level remains “bright.” In one illustrative implementation, ambient light levels above 3,000 lux are considered “bright,” ambient light levels from 16 lux to 4,400 lux are considered “normal” (or “office”-level) and ambient light levels below 70 lux are considered “dim.” Notably in this illustrative implementation, the ranges overlap. Overlapping ranges support a hysteresis effect, in which the significance of a current ambient light level depends upon previous ambient light levels. The hysteresis may be illustrated by an example. If an ambient light level rises from 1,000 lux to 3,500 lux, the processor 204 may determine that there has not been a substantial change in ambient light, because both ambient light levels are “normal,” even though the current ambient light level, if considered on its own, could be deemed either “normal” or “bright.” If the ambient light level rises again 3,500 lux to 5,000 lux, the processor 204 may determine that there has been a substantial change in ambient light, because the ambient light is no longer in the “normal” range, but is “bright.” If the ambient light level thereafter falls back from 5,000 lux to 3,500 lux, the processor 204 may determine that there has not been a substantial change in ambient light, because the ambient light level is still in the “bright” range (even though the current ambient light level, if considered on its own, could also be deemed to be “normal”). As a practical matter, hysteresis can reduce the number of adjustments to the brightness of a display where the ambient light is substantially around the border of two ranges. The portable electronic device 100 may recognize any number of ranges of ambient light, and the above lux ranges are for purposes of illustration. Further discussion about a method for determining a substantial change in ambient light will be discussed below in connection with FIG. 6.

Returning to FIG. 5: If there has been no substantial change in ambient light, then the brightness of the display 102 need not be controlled to a new brightness level. The brightness level of the display may remain at the first brightness level. The light sensor 206 may continue to generate ambient light signals at the sampling frequency under the control of the processor 204.

In the event that the processor 204 determines that there has been a substantial change in the ambient light level (i.e., a second level of ambient light is substantially changed from the first level of ambient light), the processor 204 may control the brightness of the display 102 as a function of the new ambient light level (504). The brightness of the display 102 may be controlled to a second brightness level that is different from the first brightness level. In the illustrative case of the portable electronic device 100 moving from a bright environment into a dark environment, the processor 204 may control the brightness of the display 102 by setting the display brightness to a “dim” setting. The processor 204 continues to receive ambient light signals (506) and continues to determine whether there has been a substantial change in ambient light (508). If there is no substantial change, the processor 204 may control the brightness of the display 102 to a third brightness level to accommodate adaptation (510). In this example involving dark adaptation, the first display brightness level is the brightest, the second brightness level is less bright, and the third brightness level is the least bright. The accommodation may take place after several samples of ambient light are made and compared (506, 508), and after an adaptation interval has elapsed, as illustrated in FIG. 3; or the accommodation may begin more promptly and may continue as long as there is no substantial change in the level of ambient light, as illustrated in FIG. 4. The concepts are not limited to the accommodating adaptations as shown in FIGS. 3 and 4, however. For example, the brightness of the display 102 may be maintained until half of the adaptation interval has elapsed, and thereafter the brightness of the display 102 may be reduced gradually. If further samples of ambient light indicate a further substantial change in ambient light levels (e.g., from a dark environment to an environment having normal lighting), the processor 204 may control the brightness of the display to a fourth brightness level as a function of the new ambient light level. Without a further substantial change in the level of ambient light, the processor 204 may control the brightness of the display to a fifth brightness level to accommodate adaptation (although in this example, the accommodation would be for light adaptation rather than dark adaptation).

FIG. 6 is a flow chart illustrating a technique for determining whether there has been a change in ambient light. At the outset of the method (600), it assumed that a number of ambient light signals have already been received by the processor 204, and the ambient light levels indicated by those ambient light signals have been stored in a buffer in memory 210. For purposes of illustration, it is assumed that the number of ambient light levels stored in the buffer is five, although the number may be more or fewer than five.

The processor 204 may compute a first average ambient light level as a function of the five ambient light levels stored in the buffer (602). As used herein, “average” refers to a value representative of the group of ambient light levels. The average may be (but need not be) the arithmetic mean, or it may be the median, or it may be an estimated average, or it may be a weighted average, or it may be some other representative value computed in any fashion. When a current ambient light signal is received (604), a second average ambient light level may be computed (606) that takes into account the current ambient light level (as indicated by the current ambient light signal). The second average may be computed in the same way as the first, or a different representative value may be chosen. The first and second averages may be compared to the average ambient light level (606). A substantial change may be indicated (608) when the first average light level is substantially different from the second average light level. As described above, a change may be deemed substantial when (for example) the first average is not in the same ambient light level range as the second average.

A potential benefit of using average values that take into account past ambient light levels is that a single odd sampling or a fluctuation in ambient light level will not necessarily trigger the processor 204 to change the brightness of the display 102. Using average values can reduce the effect of single ambient light samples while still supporting reasonably rapid adjustments to the brightness of the display 102 when there has been a substantial change in the lighting environment.

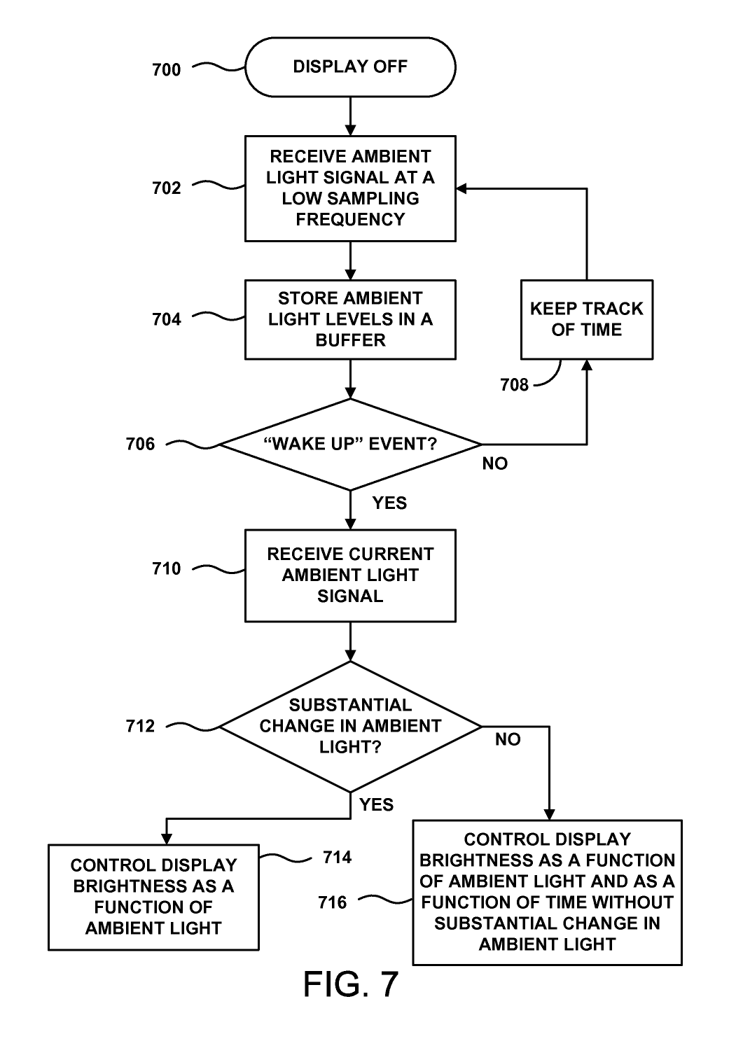

FIG. 7 is a flow chart illustrating another method that may be carried out automatically by a portable electronic device 100, typically by the processor 204. In this method, it may be assumed for simplicity that the display 102 is turned off (e.g., to conserve power during times of inactivity) (700). For purposes of illustration, it will be assumed that the portable electronic device 100 is in a dark room, and has been so for a considerable time. When the portable electronic device 100 is inactive, the ambient light may be sampled less frequently (702) than when the portable electronic device 100 is active. The ambient light levels may be stored in a buffer (704), that is, saved in memory 210 temporarily, as described previously. Although not depicted in FIG. 7, the ambient light levels may be averaged, as described in connection with FIG. 6. Apart from occasional functions, the inactive portable electronic device 100 is “asleep,” consuming power at level that is low in comparison to when the device is active and user interaction is more frequent. The portable electronic device 100 may experience a “wake up” event (706), but in the event there is no such “wake up” event, the processor 204 may measure or keep track of the length of time that the ambient light level has been without substantial change (708). Keeping track of time may be accomplished by, for example, monitoring the time with a clock or timer. Another illustrative way to keep track of time is to count or measure the number of the number of samples of ambient light that have been taken, and estimating the time based upon the sampling frequency and the number of samples.

As mentioned previously, there may be some circumstances, such as when the portable electronic device 100 is in a holster, that ambient light might not be sampled. In those circumstances, the portable electronic device 100 may omit the method of FIG. 7. In a variation, the processor 204 in a holstered portable electronic device may keep track of how long it has been holstered, and may treat that as the length of time that the ambient light level has been without substantial change.

In the event the processor 204 experiences a “wake up” event (706), the portable electronic device 100 may exit its “asleep” state. A “wake up” event is any event that triggers an exit from the “asleep” state, typically an event that causes the portable electronic device to be ready for more activity and that may entail increased power consumption. An example of a wake-up event may be an incoming telephone call. The “wake up” event may prompt the portable electronic device 100 to sound a ringtone and present images on the display 102. In the case of an incoming telephone call, for example, the display 102 may present the identification of the caller. A wake up event may also be a detected sound or a touch or some other external stimulus. The wake-up event need not be generated in response to external signals or stimuli; for example, the portable electronic device may experience a “wake up” event at a particular time of day, and may sound an alarm loud enough to wake a sleeping user at a particular time selected by the user.

Optionally, the “wake up” may prompt the portable electronic device 100 to receive a new or current ambient light signal (710), and may further optionally prompt the processor 204 to change the ambient light sampling frequency to a higher sampling frequency. In the event there has been a substantial change in ambient light (712), the processor 204 may control the brightness of display 102 as a function of the new ambient light level (714). In the event there has not been a substantial change in the level of ambient light, the processor 204 may control the brightness of display 102 to set the brightness of the display as a function of the ambient light level and as a function of the time that the ambient light level has been without substantial change (716). In this way, the processor 204 may control the brightness of display 102 to accommodate the expected adaptation of the eyes of the user.

In a conventional control of display brightness, the processor 204 may control the brightness of display 102 as a function of the current ambient light level. In the method of FIG. 7, by contrast, the processor 204 may control the brightness of display 102 as a function of the current ambient light level and how long that ambient light level has been present. If the ambient light level is without substantial change for the length of an adaptation interval (or longer), for example, the processor 204 may control the brightness of display 102 to accommodate the expected adaptation of the eyes of the user (716). In a variation, the processor 204 may, using fuzzy logic for example, control the brightness of display 102 to one of many intermediate states (e.g., between the “dim” state and the “dark” state, as illustrated in FIG. 4) as a function of the length of time that the ambient light level is without substantial change.

The method depicted in FIG. 7 may be illustrated by an example. When repeated ambient light samples over several minutes are consistent with a dark or dim environment, and if there is no interaction between the user and the portable electronic device 100, the situation may be that the portable electronic device is in a dark room. If the user is in the dark room as well, then the user may be sleeping or trying to sleep. If the ambient light levels have been without substantial change for (for example) eight minutes, the user's eyes may have undergone substantial adaptation to the environment, regardless of what the user is doing. Accordingly, when the “wake up” event occurs (such as an incoming phone call), the processor 204 may control the brightness of the display 102 as a function of the current ambient light level (thereby avoiding setting the brightness of the display 102 to a level for a bright or normal environment), and may further control the brightness of the display 102 as a function of the time that the ambient light level has been without substantial change. The processor 204 may control the brightness of the display 102 for a “dark” setting rather than a “dim” setting (or in a variant described above, may control the brightness to a setting between “dark” and “dim”). The “dark” (or darker) setting may be more pleasant than the “dim” setting for a user whose eyes have adapted (completely or in part) to the dark environment. In the event the user turns on lights before attending to the phone call, the processor 204 may determine that there has been a substantial change in the ambient light level (712) and control the brightness of the display 102 as a function of the new (e.g., normal) ambient light level (714).

Methods such as those shown in FIGS. 5 and 7 may be used individually or in concert. For example, a portable electronic device 100 may wake up and the processor 204 may control the brightness of display 102 as a function of the new ambient light level (714), and thereafter, the brightness of the display may change (510) without substantial change in the ambient light level. Further, methods such as those depicted in FIGS. 5 and 7 may be used in concert with many other illumination schemes, such as schemes that illuminate as a function of the content of the displayed image (e.g., illuminating a moving picture more than a page of text), schemes that take into account the inherent brightness of the image (whether the image is predominantly white or predominantly black, for example) or schemes that control illumination of the display 102 and other components (such as keys 108) in substantially the same fashion.

The concepts may be adapted to a variety of display illuminating schemes. For example, the concepts may be adapted to portable electronic devices that have more or fewer ambient light ranges, or that control the displays to more or fewer discrete brightness levels, or to no discrete brightness levels at all. The concepts may be applied to a variety of systems that may sample ambient light at different frequencies or in different ways. The concepts may be applied to portable electronic devices that use fuzzy logic and those that do not. It is not essential to the concepts herein that light and dark adaptation be accommodated in substantially the same way. In some embodiments, the concepts may be applied to accommodate for dark adaptation, but to provide no accommodation for light adaptation, or vice versa.

Various implementations of one or more of the embodiments of the concept may realize one or more advantages. Some of these possible advantages have been mentioned already, such as the potential to have a display that is illuminated in a more pleasant and aesthetically pleasing manner. Some embodiments may be deemed courtesies to others proximate to the user. For example, patrons in a movie theatre may be less distracted by a display that takes into account adaptation. As previously suggested, the concepts may be advantageous in that they may be flexibly applied to a variety of portable electronic devices, a variety of display types, and a variety of illuminating schemes. Further, the concepts may be readily implemented without significant additions of size, space or weight in a portable electronic device. Considerations of size, space and weight may be of added importance when the portable electronic device is a handheld device. Further, controlling the brightness of a display to dimmer levels, as may be done to accommodate dark adaptation, may conserve power.

The above embodiments are for illustration, and although one or more particular embodiments of the device and method have been described herein, changes and modifications may be made thereto without departing from the disclosure in its broadest aspects and as set forth in the following claims.

What is claimed is:

1. A method comprising:
controlling a brightness of a display of a portable electronic device to a first brightness level as a function of a first level of ambient light;
controlling the brightness of the display to a second brightness level as a function of a second level of ambient light, the second level of ambient light being substantially changed from the first level of ambient light; and
without a substantial change in the ambient light level, subsequently controlling the brightness of the display to a third brightness level.

2. The method of claim 1, wherein:
the second level of ambient light is lower than the first level of ambient light;
the second brightness level is lower than the first brightness level; and
the third brightness level is lower than the second brightness level.

3. The method of claim 1, wherein subsequently controlling the brightness of the display to the third brightness level comprises controlling the brightness of the display to the third brightness level after an adaptation interval elapses, the adaptation interval beginning when the brightness of the display is controlled to the second brightness level.

4. The method of claim 3, wherein the adaptation interval is a time between five and thirty minutes.

5. The method of claim 1, further comprising controlling the brightness of the display to a fourth brightness level as a function of a third level of ambient light, the third level of ambient light being substantially changed from the second level of ambient light.

6. The method of claim 1, further comprising:
receiving a first ambient light signal, wherein the first ambient light signal is a function of the first level of ambient light; and
receiving a second ambient light signal, wherein the second ambient light signal is a function of the second level of ambient light.

7. A portable electronic device comprising:
a display having a controllable brightness;
a light sensor that generates ambient light signals as a function of ambient light levels;
a memory; and
a processor that:
receives the ambient light signals;
determines levels of ambient light as a function of the ambient light signals;
stores in memory at least one level of ambient light;
controls the brightness of the display to a first brightness level as a function of a first level of ambient light;
controls the brightness of the display to a second brightness level as a function of a second level of ambient light, the second level of ambient light being substantially changed from the first level of ambient light; and
without a substantial change in the ambient light level, subsequently controls the brightness of the display to a third brightness level.

8. The device of claim 7, wherein the processor is further adapted to:
determine that a third level of ambient light is substantially changed from the second level of ambient light.

9. The device of claim 7, wherein the display comprises a backlight, and wherein the processor controlling the brightness of the display comprises the processor controlling the brightness of the backlight.

10. The device of claim 7, further comprising a key having a controllable brightness, wherein the processor is configured to control the brightness of the key.

11. The device of claim 7, wherein the processor is further adapted to:
measure a length of time that an ambient light level has been without substantial change;
control the brightness of the display of the portable electronic device to the third brightness level as a function of a level of ambient light and as a function of the length of time.

12. A method comprising:
measuring a length of time that an ambient light level has been without substantial change;
experiencing a wake up event; and
subsequently controlling a brightness of a display of a portable electronic device to a brightness level as a function of a level of ambient light and as a function of the length of time.

13. The method of claim 12, further comprising:
prior to experiencing the wake up event, sampling the ambient light level at a first sampling frequency; and
after experiencing the wake up event, sampling the ambient light level at a second sampling frequency, the second sampling frequency being higher than the first sampling frequency.

14. The method of claim 12, wherein experiencing the wake up event comprises receiving a telephone call.

15. A non-transitory computer program product comprising a computer readable medium embodying program code executable by a processor that cause the processor to:
control a brightness of a display of a portable electronic device to a first brightness level as a function of a first level of ambient light;
control the brightness of the display to a second brightness level as a function of a second level of ambient light, the second level of ambient light being substantially changed from the first level of ambient light; and
subsequently control the brightness of the display to a third brightness level without a substantial change in the ambient light level.

16. The computer program product of claim 15, wherein the program code that causes the processor to subsequently control the brightness of the display to the third brightness level comprises program code that causes the processor to control the brightness of the display to the third brightness level after an adaptation interval elapses, the adaptation interval beginning when the brightness of the display is controlled to the second brightness level.
